(19) United States
(12) Patent Application Publication
(10) Pub. No.: US 2010/0332747 A1
(43) Pub. Date: Dec. 30, 2010

(54) STORAGE DEVICE, INFORMATION PROCESSING SYSTEM, AND COMPUTER PROGRAM PRODUCT

(75) Inventors: Ryousuke TOMIOKA, Nagoya (JP); Taichi EJIRI, Nagoya (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/821,951

(22) Filed: Jun. 23, 2010

(30) Foreign Application Priority Data
Jun. 26, 2009 (JP) 2009-151894

(51) Int. Cl. G06F 12/08; G06F 12/00

(52) U.S. Cl. 711/113; 711/E12.001; 711/E12.019

(57) ABSTRACT

Ease of operation is improved by making it easier for the operator to monitor and select a storage medium device connected to a computer device. The device is a USB hard disk connected to a personal computer, and includes a disk, a cache memory, a push-button, and an LED. When the push-button is pushed (S110; YES), the data held in the cache memory is written to the disk (Step S220).

### CROSS REFERENCE TO RELATED APPLICATIONS

The present application claims the priority based on Japanese Patent Application No. 2009-151894 filed on Jun. 26, 2009, the disclosure of which is hereby incorporated by reference in its entirety.

### BACKGROUND

1. Technical Field

The present invention relates to a storage device for connection to an information processing device, to an information processing system furnished with the storage device, and to a computer program product for the storage device.

2. Description of the Related Art

Typically, when a storage device connected to a personal computer (hereinafter “PC”) is to be disconnected, the operator must first perform an appropriate disconnection process. An example is a process whereby, through an operation on the PC, an instruction to disconnect the storage device is issued from the PC, and once the storage device is dismounted it is then disconnected. If the operator physically disconnects the device without first performing this disconnection process, a data may not be stored correctly on the storage device.

The process of issuing a disconnection instruction as described above was not a simple one and was bothersome for the operator. Accordingly, there has been proposed a technique whereby the storage device is provided with a disconnect button, and when the operator operates the disconnect button, the storage device goes into the dismounted state. According to this feature, the operator can dismount the storage device simply by pressing the disconnect button.

However, conventionally, once the storage device is dismounted, access is no longer possible, so in order to re-access the device prior to disconnection it was necessary to perform an operation on the PC to mount the device, to unplug and reconnect the storage device, to again push a button provided to the storage device, or the like. A resultant problem was considerable inconvenience in re-accessing the device after being dismounted.

### SUMMARY

Accordingly, an object of the present invention is to provide a simple procedure for safely disconnecting a storage device, and on the basis thereof to afford greater convenience during re-access prior to disconnection.

The present invention is addressed to attaining the above objects at least in part according to the following aspects of the invention.

A first aspect of the present invention provides a storage device for connection to an information processing device. The storage device includes a storage medium for storing data; a cache memory for temporarily holding data to be transferred to the storage medium; an operating command reception module for receiving a prescribed operating command by an operator; and a data recovery module adapted to write data held in the cache memory to the storage medium when the prescribed operating command is received by the operating command reception module.

According to this storage device, when a prescribed operating command is received from the operator, data currently held in the cache memory is written to the storage medium, thereby avoiding situations in which data in the cache memory is lost without being written to the storage medium. Thus, once writing of the data by the data recovery module is completed, the data in the storage device is not destroyed even if the storage device is physically disconnected. Additionally, because the storage device is maintained in the mounted state even after the data recovery module has finished writing the data, no special operation is needed if the operator wishes to discontinue the storage device disconnection process and instead re-access the device. This affords considerable convenience during re-access prior to disconnection.

A second aspect of the present invention provides an information processing system that includes an information processing device and the storage device according to the first aspect of the invention. The information processing device includes a second cache memory for temporarily holding data to be transferred to the storage medium; an alert signal reception module for receiving from the storage device an alert signal indicating that the prescribed operating command was received; and a data transmission module that transmits the data held in the second cache memory to the storage device when the alert signal is received by the alert signal reception module. The storage device includes a data reception module for receiving data sent by the data transfer module of the information processing device; and a second data recovery module for writing the received data to the storage medium.

According to this information processing system, when a prescribed operating command by the operator is received, both data currently held in the cache memory on the storage device end and data currently held in the second cache memory on the information processing device end are written to the storage medium, thereby avoiding situations in which data in either cache memory is lost without being written to the storage medium. Thus, once writing of the data by the data recovery modules is completed, the data in the storage device is not destroyed even if the storage device is physically disconnected. Further, like the storage device according to the first aspect of the invention, this information processing system affords the advantage of considerable convenience during re-access of the storage device prior to disconnection.

A third aspect of the present invention provides a computer program product for a storage device. The storage device is connected to an information processing device and includes a storage medium for storing data, and cache memory for temporarily holding data to be transferred to the storage medium. The computer program product includes a computer readable medium and a computer program stored on the computer readable medium. The computer program includes a portion for receiving a prescribed operating command by an operator; a portion for writing data held in the cache memory to the storage medium when the prescribed operating command is received.

The third aspect of the invention affords working effects comparable to the storage device according to the first aspect of the invention.

The present invention can be realized in various additional modes such as a computer program composed of the program codes provided to the computer program product in accordance with the preceding third aspect; or a data signal containing the computer program and carried on a carrier wave.

### BRIEF DESCRIPTION OF THE DRAWINGS

FIG. 1 is an illustration depicting the general features of an information processing system 100 according to a first embodiment of the present invention;

FIG. 2 is a flowchart showing control processes executed by a bridge controller 24 and a disk controller 36 provided to a USB hard disk 20;

FIG. 3 is an illustration showing an overview of operation of various components when a push button 42 is pushed by the operator;

FIG. 4 is an illustration depicting the general features of an information processing system 200 according to a second embodiment of the present invention; and

FIG. 5 is an illustration showing an overview of operation of various components when a push button 42 is pushed by the operator.

### DESCRIPTION OF THE PREFERRED EMBODIMENTS

The embodiments of the present invention are described below, with reference to the accompanying drawings.

### A. Embodiment 1

### A-1: Hardware Configuration

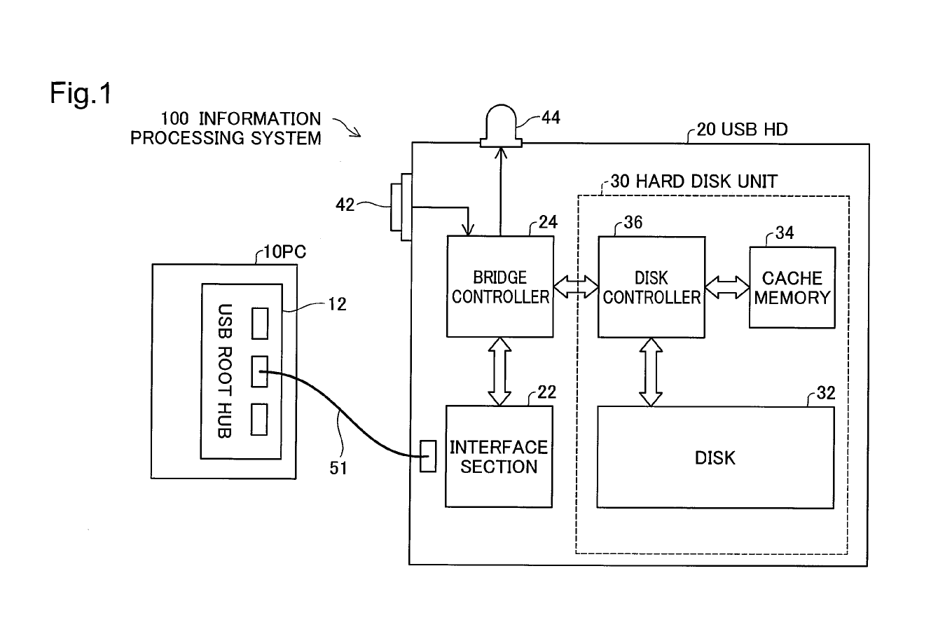

FIG. 1 is an illustration depicting the general features of an information processing system 100 according to a first embodiment of the present invention. As shown, the information processing system 100 includes a personal computer 10 provided as an information processing device, and a USB hard disk 20 provided as a storage device.

The personal computer (hereinafter PC) 10 is furnished with a USB root hub 12 which provides connectivity with USB devices. In the present embodiment, a USB device, in this case the USB hard disk 20, connects via a USB cable 51.

The USB hard disk 20 is equipped with an interface section 22, a bridge controller 24, and a hard disk unit 30. The interface section 22 constitutes an interface for the purpose of USB connection to the PC 10.

The bridge controller 24 is connected to the interface section 22 and to the hard disk unit 30, and is designed to control sending and receiving of data to and from the PC 10 via the interface section 22, as well as to control data write processes and read processes to and from the hard disk unit 30. The bridge controller 24 is composed of a small microcomputer furnished with a CPU, memory, and so on. However, the circuit could be composed of several discrete electronic components rather than designed as small microcomputer.

The hard disk unit 30 includes a disk 32 as the storage medium; a cache memory 34 for temporarily holding data sent via the bridge controller 24; and a disk controller 36. The disk controller 36 is connected to the aforementioned bridge controller 24, disk 32, and cache memory 34, and performs writing to and reading from the disk 32. Specifically, the disk controller 36 writes data to the disk 32 while temporarily holding in the cache memory 34 data sent to it from the bridge controller 24, while; and reads out data stored on the disk 32 and sends it to the bridge controller 24 while temporarily holding the data the cache memory 34. The disk controller 36 is composed of a small microcomputer furnished with a CPU, memory, and so on. However, the disk controller 36 could be composed of several discrete electronic components rather than designed as small microcomputer.

A push-button 42 and an LED (Light Emitting Diode) 44 are mounted on the enclosure of the USB hard disk 20. The push-button 42 and the LED 44 are connected to the bridge controller 24.

The push-button 42 is a switch operated by the operator in order to place the USB hard disk 20 in a state in which it can be safely disconnected. Specifically, when the operator pushes the push-button 42, a command to enable disconnection of the USB hard disk 20 from the PC 10 is sent to the USB hard disk 20.

The bridge controller 24 lights the LED 44 to alert the user that the USB hard disk 20 can be safely disconnected. In an alternative arrangement, a speaker may be provided in place of the LED 44 to provide the operator with an audible alert. However, there is no intention to limit the arrangement to light or sound, provided that the arrangement is capable of alerting the operator. For example, in one possible arrangement, the PC 10 is notified when the USB hard disk 20 can be safely detached, and a message to this effect is then displayed by the PC 10.

### A2. Software Configuration

Operations that take place in the USB hard disk 20 when the push-button 42 is pushed by the operator are described in detail below.

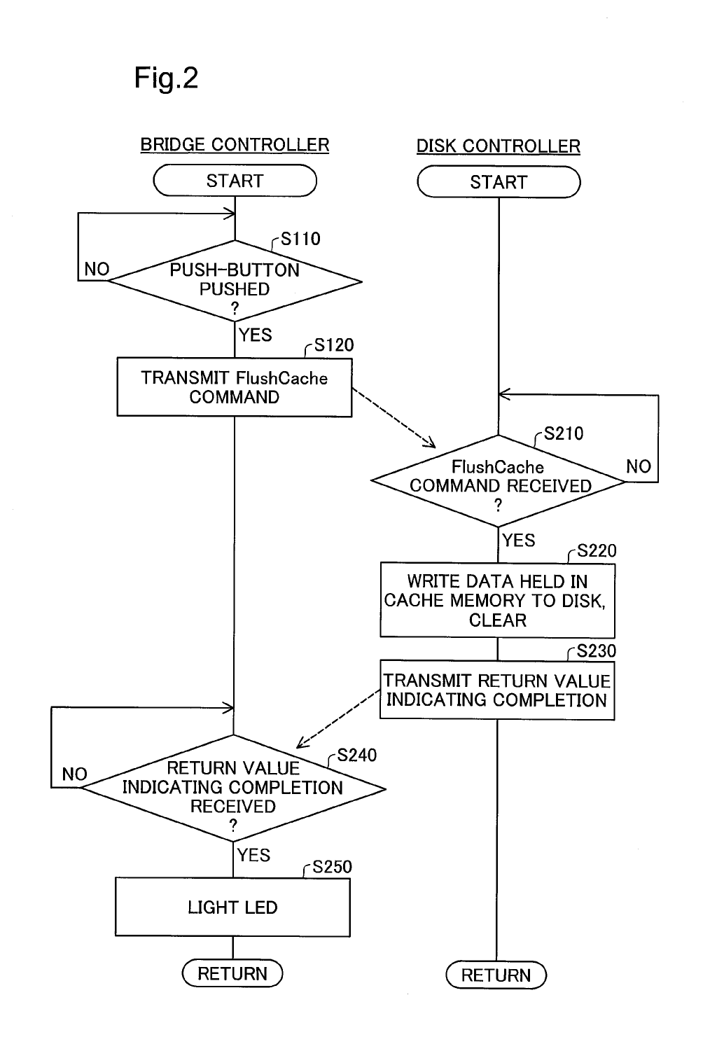

FIG. 2 is a flowchart showing control processes executed by the bridge controller 24 and the disk controller 36 provided to the USB hard disk 20. Each control process is accomplished through execution, by the respective CPUs, of prescribed computer programs that are stored in memory the bridge controller 24 and the disk controller 36 respectively. The computer programs could also be saved in advance in ROM; stored on the disk 32; distributed on various recording media (computer-readable storage media) such as CD-ROM; or distributed electronically through various communication means such as the Internet.

As shown in FIG. 2, when the process starts, the bridge controller 24 decides whether the operator pushed the push-button 42 (Step S110). At this point, if decided that the button was not pushed (Step S110: NO), the decision in Step S110 is made repeatedly to wait for the button to be pushed.

On the other hand, if in Step 110 it is decided that the bridge controller 24 was pushed (Step S110: YES), the bridge controller 24 transmits a FlushCache command to the disk controller 36 (Step S120). The FlushCache command is a command to write data currently held in the cache memory 34 to the disk 32, and to then clear the cache memory 34.

Meanwhile, the disk controller 36 decides whether a FlushCache command was received (Step S210). If decided that a command was not received (Step S210: NO), the process of Step S210 repeats to wait for a FlushCache command to be received. If decided in Step S210 that a FlushCache command was received (Step S210: YES), the disk controller 36 writes data currently held in the cache memory 34 to the disk 32, and then subsequently clears the cache memory 34 (Step S220).

After executing Step S220, the disk controller 36 transmits to the bridge controller 24 a return value indicating that clearing of the cache memory 34 was completed (Step S230). After executing Step S230, the disk controller 36 exits to “RETURN” and terminates the process.

The bridge controller 24 waits for the disk controller 36 to send it a return value indicating that clearing of the cache memory 34 was completed, and receives the return value (Step S240: YES). The bridge controller 24 then lights up the LED 44 (Step S250). After executing Step S250, it exits to “RETURN” and terminates the process.

After a prescribed interval has elapsed, the lighted LED 44 is extinguished by the bridge controller 24. The “prescribed interval” in this instance can refer for example to a specific time interval, or the duration until the USB hard disk 20 and the personal computer 10 are physically disconnected by the operator.

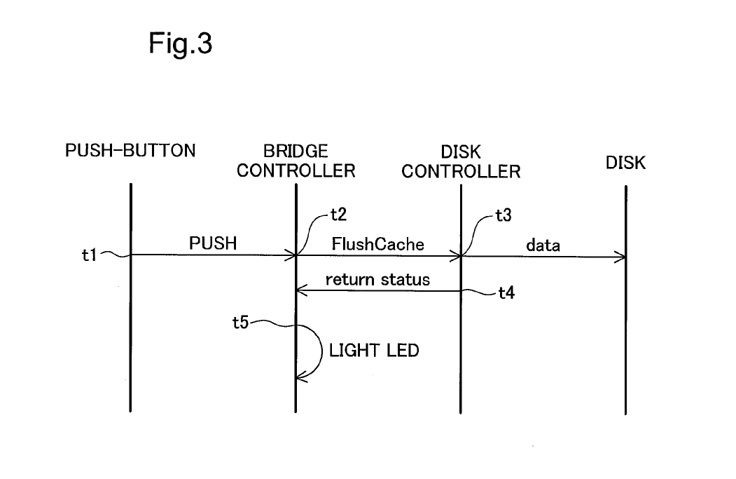

FIG. 3 is an illustration showing an overview of operation of various components when a push button 42 is pushed by the operator. Whereas the flowchart described previously is intended to elucidate respective control by the bridge controller 24 and the disk controller 36, FIG. 3 depicts the operations over time in order to provide a better understanding.

As shown in FIG. 3, when the push-button 42 is pushed (timing t1), the bridge controller 24 receives notification to this effect, and transmits a FlushCache command to the disk controller 36 (timing t2). Upon receiving the FlushCache command, the disk controller 36 writes data currently held in the cache memory 34 to the disk 32 (data: timing t3). The disk controller 36 also returns to the bridge controller 24 a return value indicating that the clearing of the cache memory 34 was completed (return status: timing t4).

Upon receiving “return status”, the bridge controller 24 lights the LED 44 (timing t5).

### A-3. Working Effects

According to the USB hard disk 20 provided to the information processing system 100 of Embodiment 1 having the features described above, when the operator pushes the push-button 42, data held in the cache memory 34 is written to the disk 32, thereby avoiding situations in which unsaved data in the cache memory 34 is lost without being written to the disk 32. Thus, once writing of the data to the disk 32 is finished, data on the USB hard disk 20 is not destroyed even if the USB hard disk 20 is physically disconnected. Further, because the USB hard disk 20 is maintained in the mounted state even after writing of the unsaved data in the cache memory 34 has finished, no special operation is needed if the operator should wish to discontinue disconnecting the USB hard disk 20 and instead re-access the device. Consequently, Embodiment 1 affords considerable convenience during re-access prior to disconnection.

Further, according to this USB hard disk 20, it is safe for the operator to physically disconnect the device once the LED 44 has lighted, thereby avoiding the risk of disconnecting the USB hard disk 20 while data is being written from the cache memory 34 to the disk 32.

### B. Embodiment 2

### B-1: Hardware Configuration

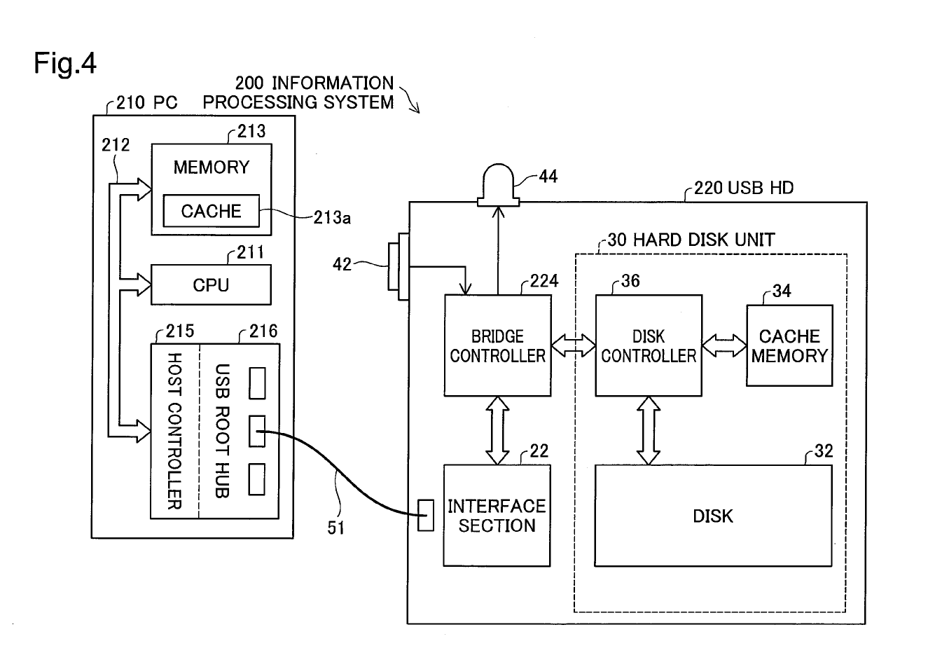

FIG. 4 is an illustration depicting the general features of an information processing system 200 according to a second embodiment of the present invention. As shown, like the system in Embodiment 1, the information processing system 200 includes a PC 210 and a USB hard disk 220.

The PC 210 includes a CPU 211 as the central processing unit, as well as a memory 213, a host controller 215, and a USB root hub 216, which are interconnected by a bus 212. The memory 213 stores various types of data and various programs, and serves as the working area for the CPU 211. The memory 213 also includes a cache 213a for use by the USB hard disk 220. This cache 213a corresponds to the “second cache memory” recited in the claims. In actual practice, the cache 123a is constituted as an area in the memory 213, but could instead be provided as a storage medium separate from the memory 213.

The host controller 215 is a USB interface unit. The USB root hub 216 is integrated with the host controller 215.

The PC 10 in Embodiment 1 was described as including a USB root hub 12; however, to describe in more detail, like Embodiment 2 it includes a CPU, memory, a host controller, and a USB hub. To compare the PC 10 of Embodiment 1 and the PC 210 of Embodiment 2, the two differ in that whereas the PC 10 Embodiment 1 lacks a cache for use by the USB hard disk 20, the PC 210 of Embodiment 2 includes in the memory 213 a cache 213a for use by the USB hard disk 220.

The USB hard disk 220 has the same hardware configuration as the USB hard disk 20 of Embodiment 1, and differs only in the control process executed by the bridge controller 224. Parts other than the bridge controller 224 are assigned the same symbols as in Embodiment 1.

### B-2. Software Configuration

Operations of the PC 210 and the USB hard disk 220 that take place in the USB hard disk 220 when the push-button 42 is pushed by the operator are described in detail below.

In Embodiment 1, a flowchart was used to describe operations, but the description of Embodiment 2 does not make reference to a flowchart. In Embodiment 2, the relationships among three components, namely, the CPU 211 provided to the PC 210, the bridge controller 224 provided to the USB hard disk 220, and the disk controller 36 provided to the USB hard disk 220, would make any flowchart rather complicated.

In Embodiment 2, the configuration is such that pushing of the push-button 42 of the USB hard disk 220 can be detected on the PC 210 side. Specifically, the CPU 211 of the PC 210 polls the bridge controller 224 of the USB hard disk 220 to query as to whether the push-button 42 was pushed.

If in response to polling, the CPU 211 of the PC 210 receives from the bridge controller 224 a response that the push-button 42 was pushed, data held in the cache 213a provided for the USB hard disk 220 in the memory 213 is transferred to the USB hard disk 220 side, where it is saved to the disk 32 of the USB hard disk 220. When saving to disk has been completed, the USB hard disk 220 then writes the data held in the cache memory 34 of the USB hard disk 220 to the disk 32 by a method comparable to that of Embodiment 1.

As a result, when the push-button 42 of the USB hard disk 220 is pushed by the operator, both data held in the cache 213a provided in the memory 213 of the PC 210 and data held in the cache memory 34 of the USB hard disk 220 are written to the disk 32.

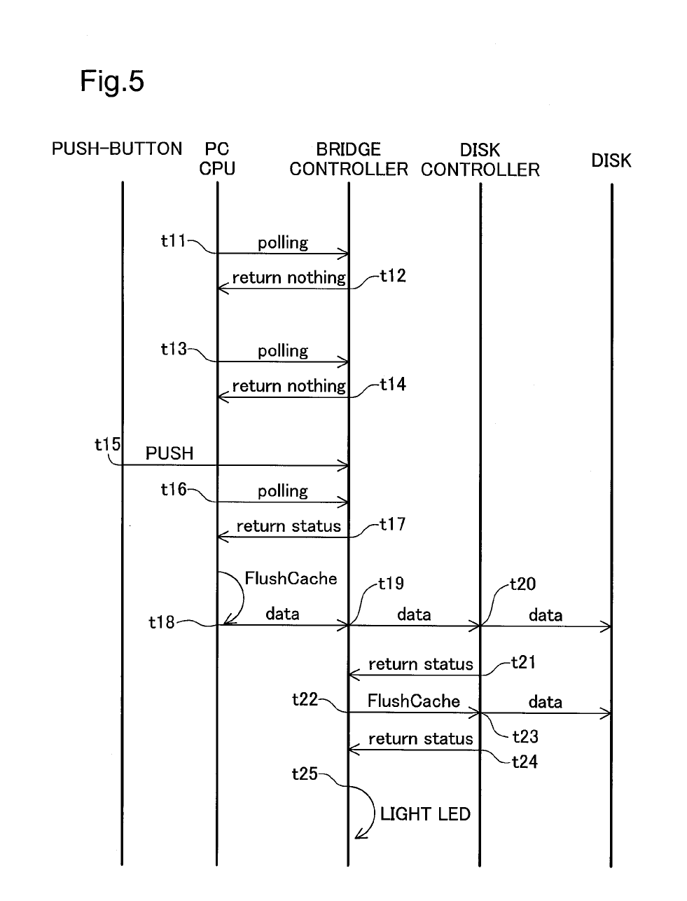

FIG. 5 is an illustration showing an overview of operation of various components when the push button 42 is pushed by the operator. As shown, the CPU 211 of the PC 210 caries out polling of the bridge controller 224 of the USB hard disk 220, to query as to whether the push-button 42 was pushed (timing t11, t13). If the bridge controller 224 does not detect pushing of the push-button 42, it replies to the querying PC 210 with a return value indicating the button was not pushed (timing t12, t14).

If on the other hand the operator has pushed the push-button 42 (timing t15), and the aforementioned query is subsequently received (timing t16), the bridge controller 224 replies to the PC 210 with a return value indicating the push-button 42 was pushed (return status: timing t17).

When the CPU 211 of the PC 210 receives the return value indicating that the push-button 42 was pushed, a FlushCache command is executed on the cache 213a on the PC 210 side. In this instance, data held in the cache 213a used by the USB hard disk 220 is transferred to the bridge controller 224 of the USB hard disk 220, and the cache 213a is then cleared (flush cache: timing t18).

The bridge controller 224 of the USB hard disk 220 then forwards the data that was sent to it by the PC 210 (i.e. the data that was held in the cache 213a used by the USB hard disk 220) to the disk controller 36 of the USB hard disk 220 (data: timing t19), whereupon the disk controller 36 writes the data to the disk 32 (data: timing t20). When the disk controller 36 finishes writing the data, it returns write complete status to the bridge controller 224 (return status: timing 21).

Upon receiving the write complete status, the bridge controller 224 transmits a FlushCache command to the disk controller 36 (timing t22). When the disk controller 36 receives the FlushCache command, it writes the data held in the cache memory 34 to the disk 32, and clears the cache memory 34 (timing t23). The disk controller 36 then returns to the bridge controller 224 a return value indicating that the cache memory 34 was cleared (return status: t24).

Upon receiving the “return status”, the bridge controller 224 lights the LED 44 (timing t25). The operations taking place at timing t22 to t25 are identical to the operations taking place at timing t2 to t5 (FIG. 3) in Embodiment 1.

### B-3. Working Effects

According to the information processing system 200 of Embodiment 2 having the features described above, when the operator pushes the push-button 42 of the USB hard disk 220, data held in the cache memory 34 on the USB hard disk 220 side is written to the disk 32 together with data held in the cache 213a of the PC 210, thereby avoiding situations in which both sets of data are lost without being written to the disk 32. Thus, once writing of the data to the disk 32 is finished, data on the USB hard disk 220 is not destroyed even if the USB hard disk 220 is physically disconnected. Further, as in Embodiment 1, the information processing system 200 affords considerable convenience during re-access of the USB hard disk 220 prior to disconnection.

### C. Modifications

### Modification 1

In Embodiments 1 and 2 above, a switch of pushbutton type switch was employed for placing the USB hard disk 20, 220 in a state in which it can be safely disconnected; however, a switch of any type could be used instead, provided it allows the operator to send a prescribed operating command. For example, slider-button type could be employed. While the push-button 42 was provided to the USB hard disk 20, as an alternative feature, the USB hard disk 20 could be notified from the outside. For example, a feature whereby the operator sends a disconnect instruction from the PC side through operation of the PC 10, 210 could be employed.

### Modification 2

While Embodiments 1 and 2 illustrate examples of a USB hard disk as the storage device, other storage devices, such as a USB flash drive (USB memory) could be substituted for the USB hard disk. The storage device may also be composed of a combination of media such as an SD card or Memory Stick and a media reader.

### Modification 3

In Embodiments 1 and 2, a personal computer was shown as an example of the information processing device; however, the personal computer could be replaced by some other information processing device, such as a projector, fax machine, router, or television device.

### Modification 4

In Embodiments 1 and 2, the storage device employed a USB connection, but connection to the information processing device could instead be made through a different interface such as IEEE 1394 or eSATA. In preferred practice the interface will support hot plugging.

In the preceding embodiment and Modifications, some of the features implemented through hardware could instead by implemented through software, and conversely some of the features implemented through software could instead by implemented through hardware.

Additional aspects of the present invention are now described. The storage device according to the first aspect of the invention can be reduced to practice in the following modes as well.

The storage device may include a control switch operated by the operator to send the prescribed operating command. According to this feature, it is possible for the disconnection operation by the operator to be carried out from the storage device side.

The storage device may also include an alert module adapted to alert the operator of completion when writing of data by the data recovery module is finished. According to this feature, the operator may physically disconnect the unit after receiving an alert by the alert module, thereby avoiding the risk of disconnecting the storage device while data is being written to the storage medium by the data recovery module.

In a storage device furnished with the alert module, the alert module may include a light emitting diode for alert purposes. According to this feature, a light can be utilized to alert the operator.

In the storage device according to the first aspect of the invention, the operating command reception module may be adapted to transmit the prescribed operating command from the information device. According to this feature, it is possible for the operator to carry out the disconnection operation from the information processing device side.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

What is claimed is:

1. A storage device for connection to an information processing device, comprising:
a storage medium for storing data;
a cache memory for temporarily holding data to be transferred to the storage medium;
an operating command reception module for receiving a prescribed operating command input by an operator; and
a data recovery module adapted to write data held in the cache memory to the storage medium when the prescribed operating command is received by the operating command reception module.

2. The storage device in accordance with claim 1 including
a control switch operated by the operator to send the prescribed operating command.

3. The storage device in accordance with claim 1 including
an alert module adapted to alert the operator of completion when writing of data by the data recovery module is finished.

4. The storage device in accordance with claim 3, wherein
the alert module includes a light emitting diode for alert purposes.

5. The storage device in accordance with claim 1, wherein
the operating command reception module is adapted to transmit the prescribed operating command from the information device.

6. An information processing system comprising:
an information processing device; and
the storage device in accordance with claim 1; wherein
the information processing device includes:
a second cache memory for temporarily holding data to be transferred to the storage medium;
an alert signal reception module for receiving from the storage device an alert signal indicating that the prescribed operating command was received; and
a data transmission module that transmits data held in the second cache memory to the storage device when the alert signal is received by the alert signal reception module,
and the storage device includes:
a data reception module for receiving data sent by the data transfer module of the information processing device; and
a second data recovery module for writing the received data to the storage medium.

7. A computer program product for a storage device connected to an information processing device and including a storage medium for storing data, and a cache memory for temporarily holding data to be transferred to the storage medium, the computer program product comprising:
a computer readable medium; and
a computer program stored on the computer readable medium, the computer program comprising:
a portion for receiving a prescribed operating command by an operator;
a portion for writing data held in the cache memory to the storage medium when the prescribed operating command is received.
